(19) United States
(12) Patent Application Publication
(10) Pub. No.: US 2009/0238722 A1
(43) Pub. Date: Sep. 24, 2009

(54) Pressure-Reinforced Fluidic Chip

(75) Inventors: Jose-Angel Mora-Fillat, Waldbronn (DE); Karsten Kraiczek, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/050,265

(22) Filed: Mar. 18, 2008

(51) Int. Cl. B01J 19/00; B01D 15/08

(52) U.S. Cl. 422/68.1; 210/198.2; 210/198.3

(57) ABSTRACT

A fluidic chip device adapted for processing a fluidic sample, the fluidic chip device comprising a substrate comprising a fluidic conduit for conducting the fluidic sample under pressure, and two reinforcing structures between which the substrate is arranged, wherein the two reinforcing structures are connected to one another to reinforce pressure resistance of the substrate.

### BACKGROUND

The present invention relates to a fluidic chip device.

In liquid chromatography, a fluidic analyte may be pumped through a column comprising a material which is capable of separating different components of the fluidic analyte. Such material, so-called beads which may comprise silica gel, may be filled into a column tube which may be connected to other elements (like a control unit, containers including sample and/or buffers).

U.S. Pat. No. 7,182,371 discloses a manifold for connecting external capillaries to the inlet and/or outlet ports of a microfluidic device for high pressure applications. The fluid connector is adapted for coupling at least one fluid conduit to a corresponding port of a substrate that includes a manifold comprising one or more channels extending therethrough wherein each channel is at least partially threaded, one or more threaded ferrules each defining a bore extending therethrough with each ferrule supporting a fluid conduit wherein each ferrule is threaded into a channel of the manifold. The substrate has one or more ports on its upper surface wherein the substrate is positioned below the manifold so that the one or more ports is aligned with the one or more channels of the manifold. A device is provided to apply an axial compressive force to the substrate to couple the one or more ports of the substrate to a corresponding proximal end of a fluid conduit.

U.S. Pat. No. 6,936,167 discloses systems and methods for performing multiple parallel chromatographic separations. Microfluidic cartridges containing multiple separation columns allow multiple separations to be performed in a limited space by a single instrument containing high-pressure pumps and analyte detectors. The use of pressure fit interfaces allows the microfluidic cartridges to easily be removed and replaced within the instrument, either manually or robotically.

WO 2005/084808 by the same applicant Agilent Technologies discloses a frame for a microfluidic chip which can be used together with a laboratory apparatus. The frame is adapted at least for one of the features of receiving the microfluidic chip, and protecting the microfluidic chip, positioning the microfluidic chip relatively to the frame.

US 2004/0156753 A1 by the same applicant Agilent Technologies discloses a PEEK-based microfluidic chip device comprising two separate substrates which are bonded together to form channels where gases or liquids may move to accomplish applications of the microfluidic chip device. Thus, an internal cavity may be formed as a channel of the microfluidic chip device.

WO 2007/021810 discloses an apparatus and a method for delivering one or more fluids to a microfluidic channel. A microfluidic channel is provided in communication with a first conduit for delivering fluids to the microfluidic channel. Further, the apparatus and method can include a first fluid freeze valve connected to the first conduit and operable to reduce the temperature of the first conduit for freezing fluid in the first conduit such that fluid is prevented from advancing through the first conduit.

Operation of a liquid chromatography system may involve the application of a high pressure such as 1000 bar or more. This may be a challenge for the involved components of the liquid chromatography system.

### SUMMARY

It is an object of the invention to provide an efficient fluidic chip device. The object is solved by the independent claims. Further embodiments are shown by the dependent claims.

According to an exemplary embodiment of the present invention, a fluidic chip device (such as a biochip for a chromatographic fluid separation system) adapted for processing a fluidic sample (such as a liquid and/or gaseous sample optionally comprising solid particles) is provided, the fluidic chip device comprising a substrate (such as a single-layer substrate or multi-layer substrate) comprising a fluidic conduit (such as a capillary or channel) for conducting the fluidic sample under pressure (for instance provided by a pump), and two reinforcing structures (such as physical bodies acting to strengthen the substrate by applying an external counter pressure) between which the substrate is arranged (for instance sandwiched), wherein the two reinforcing structures are connected to one another (for example by a connection structure such as one or more posts guided for example through the substrate or around the substrate) to reinforce pressure resistance of the substrate.

According to another exemplary embodiment, a method of fabricating a fluidic chip device for processing a fluidic sample is provided, the method comprising forming (for instance by etching or deposition) a fluidic conduit in a substrate through which fluidic conduit the fluidic sample is to be conducted under pressure, arranging the substrate between two reinforcing structures, and connecting the two reinforcing structures to one another to reinforce pressure resistance of the substrate.

According to an exemplary embodiment, a pressure stable fluidic chip device may be provided in which two or more reinforcing structures enclose at least a part of an outer surface of a substrate housing a sample channel, so that the substrate may be rendered more stable or resistant against high pressures which may occur when a fluidic sample is pumped through the fluidic conduit under pressure or when a fluid separation material is inserted into the fluidic conduit before using the device, i.e. during manufacture, under pressure. By interconnecting the reinforcing structures through or around the substrate by an interconnecting structure, an external mechanical support may be provide to stabilize the substrate even in the presence of a pressure of 1000 bar or more.

Next, further exemplary embodiments of the fluidic chip device will be explained. However, these embodiments also apply to the method.

The two reinforcing structures may be plates (such as a sheet of metal or glass or plastic, or any flat body structure or part having a planar surface). Thus, the two reinforcing structures may be essentially two-dimensional planar components which may be simply put on a surface of a planar substrate to thereby provide the substrate with an external support.

A shape and a surface area of the two reinforcing structures may be provided to match to a shape and to a surface area of the substrate. Thus, the design, geometry and dimension of a surface of the reinforcing structures may fit to a corresponding surface of the substrate, thereby ensuring a safe reinforcement over essentially the entire surface area of the substrate.

The two reinforcing structures may have a thickness which is larger than a thickness of the substrate. For instance, a thickness of the reinforcing structures may be at least twice, particularly at least five times of a thickness of the essentially two-dimensional substrate. Thus, relatively thick external stabilizing plates may be foreseen to apply an external pressure on the substrate (by an interconnection structure interconnecting the reinforcing structures) making the substrate more stable against high internal pressure.

Additionally or alternatively, a mechanical resistance of the two or more reinforcing structures may be larger than a mechanical resistance of the substrate. The term mechanical resistance may refer to the capability of a material to withstand external forces before being damaged, for instance before breaking. Providing reinforcing structures having a high mechanical resistance to surround at least a part of the substrate involve no limitations regarding the material selections of the substrate, so that the substrate constitution may be optimized independently to meet requirements related to the fluid separation procedure, for instance a biocompatibility requirement.

Particularly, the two reinforcing structures may be connected to one another to reinforce the substrate by a non-positive locking mechanism. Such a non-positive locking mechanism may be a friction-locked connection, i.e. a connection which is based on a frictional force. Such a non-positive connection may be a connection where there are no projections or recesses engaging in one another. In contrast to this, two components being connected in a non-positive manner may be held together by friction. Such a connection may require that the two components are pressed firmly together, for instance by a magnetic force.

Alternatively or additionally, the two reinforcing structures may be connected to one another to reinforce the substrate by a material connection such as a substance-to-substance bond where a connection is mediated by additional material such as a layer of glue. An example is that the reinforcing structures are connected by adhering.

Alternatively or additionally, the two reinforcing structures may be connected to one another to reinforce the substrate by a positive locking mechanism. Such a positive locking mechanism may be one in which two components lock together due to the way they are shaped, for instance a projection in one engages with a recess in the other, thereby preventing relative motion of the components. However, according to an exemplary embodiment, part of the reinforcing structures (or an additional connection element) may pass through the substrate, for instance penetrating through holes formed therein in order to be connected within the substrate. This may ensure a proper fastening and protection against high pressures. Alternatively, the connection between the two reinforcing structures may be guided around the substrate, for instance completely enclosing the substrate or having a post-like connection of the reinforcing structures guided around the substrate. This may allow to implement standard substrates which do not have to be adapted to reinforcing structures according to exemplary embodiments which may have an accommodation to accommodate such a substrate.

Particularly, the two reinforcing structures may be connected to one another to reinforce the substrate by traction anchoring. In other words, traction forces may be generated by such connected reinforcing structures tightly compressing the substrate to form a counterforce to the expanding effect of a high pressure in a channel of the substrate.

Any fastener may be used for connecting the two reinforcing structures which may be integrally formed with one or both of the reinforcing structures, or which may be provided as a separate component. Such fasteners may be used permanently or temporarily, when the latter configuration allows them to be fastened and unfastened repeatedly. Exemplary systems of joining or reinforcing the substrate are crimping, welding, soldering, bracing, taping, gluing, cementing, the use of adhesives, the use of forces involving magnets, vacuum, or pure friction. Also the implementation of screws, nails, bolts, hinges or springs may be possible.

Particularly, the two reinforcing structures may be arranged to encompass the substrate. Thus, the substrate may be partially or entirely surrounded or covered by the two reinforcing structures allowing to prevent uncontrolled impact of damaging expansive forces driving the substrate to expand in response to a pressure impinged on the internal fluidic channel.

The two reinforcing structures may be connected to one another to reinforce the substrate by a screwing connection. In such an embodiment, one or more threaded bores may be provided in the reinforcing structures and/or in the substrate to connect the reinforcing structures with the substrate sandwiched in between by fastening the screws, for instance using a corresponding screw nut.

It is also possible that the two reinforcing structures are connected using a clamping connection. This may involve sufficiently strong spring forces acting on the reinforcing structures or directly on the substrate to generate a counterforce in the opposite direction of expanding forces generated by a high pressure applied to the fluidic channel.

At least one of the two reinforcing structures may comprise a fluidic sample drain opening adapted to drain a fluidic sample discharging from the fluidic conduit. In a substrate such as a chip for biochemical analysis or the like, it is possible that the fluidic sample is to be drained after being guided through the fluidic channel out of a surface of the substrate which is, according to an exemplary embodiment, covered by one or both of the two reinforcing structures. In such an embodiment, a fluid adapter or a fluid interface may be formed in the reinforcing structure which may allow to get external access to the fluidic sample discharging from the fluidic conduit even when the corresponding surface of the substrate is covered by one of the reinforcing structures.

At least one of the at least two reinforcing structures may comprise an attachment piece adapted for inserting a separation substance in the fluidic conduit under pressure. A separation substance such as beads having fluid separation properties may also be filled in a channel under a high pressure, for example during manufacture. When the reinforcing structures surround the substrate at least during such a manufacturing or filling procedure, it can be ensured that the packing material is provided safely within a dedicated portion of the fluidic channel with a sufficiently large packing density. After such a fill-in procedure, it is possible to remove the two reinforcing structures for normal use. However, since also the pumping of a liquid sample through the fluidic channel may be performed under high pressure conditions during actual use of the fluidic chip device, it is also possible that the reinforcing structures remain enclosing the substrate during the actual separation procedure.

At least one of the two reinforcing structures may have a thickness (in a stacking direction of the substrate and the two reinforcing structures which may be located on top of one another) in a range between basically 1 mm and basically 30 mm, particularly in a range between basically 2 mm and basically 10 mm, more particularly in a range between basically 4 mm and basically 6 mm. Additionally or alternatively, the substrate may have a thickness (in a stacking direction of the substrate and the two reinforcing structures which may be located on top of one another) in a range between basically 25 μm and basically 300 μm, particularly in a range between basically 50 μm and basically 200 μm, more particularly in a range between basically 70 μm and basically 150 μm. The substrate may be a planar and very thin structure which may be essentially two-dimensional, for instance similarly shaped as a credit card. In contrast to this, the reinforcing structures may be for instance rectangular plates having a significantly larger thickness and stability, to thereby provide the required stabilizing forces.

The two reinforcing structures may comprise a metal. For instance a steel sheet may be appropriate, since it is sufficiently robust and mechanically stable and cheap as well. However, the reinforcing structures may also comprise a hard plastic, i.e. a plastic material having a sufficient mechanical stability. The stability should be such that the hard plastic reinforcing structures may be capable to bear pressure forces of 600 bar, particularly of 1200 bar.

The reinforcing structures may be formed by injection molding. They may be formed as injection molded parts manufactured separately from the substrate, or may be injection molded onto the substrate. The latter procedure has the advantage that this results in an automatic fastening of the reinforcing structures at the substrate during the injection molding procedure.

The substrate may be a multi-layer substrate. In other words, the substrate may be formed of a plurality of layers which may be connected to one another, for instance which may be laminated. Within any layer of such a multi-layer substrate, a structure for the fluidic chip application may be formed, such as a conduit, electrode structures, separation channels, frits, valves, heating elements, sensor elements such as temperature sensors, etc. By laminating such components together, a high performance fluidic chip device may be provided which however may suffer from the mechanical weakening of the laminated multi-layer structure. According to an exemplary embodiment, such a problem may be overcome by externally stabilizing such a multi-layer substrate, preventing delamination or the like.

The substrate may comprise one or more through holes through which a connection element (such as columns, posts or pillars) may be guided which connect(s) the two reinforcing structures to one another. By forming one or more of such through holes, a direct connection of the externally positioned reinforcing structures may be made possible, thereby providing additional mechanical support to the substrate relative to the reinforcement structures and between the two reinforcement structures.

The substrate may comprise a plurality of layers. For instance, three or five layers may form a laminar structure of the fluidic device which may allow for providing all the required components of the fluidic device within the layered structure. Particularly, the substrate may comprise a top layer, a bottom layer and at least one intermediate layer sandwiched between the top layer and the bottom layer. The at least one intermediate layer may comprise a conduit through which the fluidic sample is to be conducted.

The substrate may have an essentially rectangular cross section. Furthermore, the substrate may have a plate-like shape. Typical dimensions of the substrate are a thickness of 0.3 mm or less, and a dimension of several cm in length and in width.

At least a part of a processing element provided in the substrate may be filled with a fluid separating material. Such a fluid separating material which may also be denoted as a stationary phase may be any material which allows an adjustable degree of interaction with a sample so as to be capable of separating different components of such a sample. The fluid separating material may be a liquid chromatography column filling material or packing material comprising at least one of the group consisting of polystyrene, zeolite, polyvinylalcohol, polytetrafluorethylene, glass, polymeric powder, silicon dioxide, and silica gel. However, any packing material can be used which has material properties allowing an analyte passing through this material to be separated into different components, for instance due to different kinds of interactions or affinities between the packing material and fractions of the analyte.

At least a part of the processing element may be filled with a fluid separating material, wherein the fluid separating material may comprise beads having a size in the range of essentially 1 μm to essentially 50 μm. Thus, these beads may be small particles which may be filled inside the separation column. The beads may have pores having a size in the range of essentially 0.02 μm to essentially 0.03 μm. The fluidic sample may be passed through the pores, wherein an interaction may occur between the fluidic sample and the pores. By such effects, separation of the fluid may occur.

The fluidic chip device may be adapted as a fluid separation system for separating components of the mobile phase. When a mobile phase including a fluidic sample is pumped through the fluidic chip device, for instance with a high pressure, the interaction between a filling of the column and the fluidic sample may allow for separating different components of the sample, as performed in a liquid chromatography device or in a gel electrophoresis device.

However, the fluidic chip device may also be adapted as a fluid purification system for purifying the fluidic sample. By spatially separating different fractions of the fluidic sample, a multi-component sample may be purified, for instance a protein solution. When a protein solution has been prepared in a biochemical lab, it may still comprise a plurality of components. If, for instance, only a single protein of this multi-component liquid is of interest, the sample may be forced to pass the columns. Due to the different interaction of the different protein fractions with the filling of the column (for instance using a gel electrophoresis device or a liquid chromatography device), the different samples may be distinguished, and one sample or band of material may be selectively isolated as a purified sample.

The fluidic chip device may be adapted to analyze at least one physical, chemical and/or biological parameter of at least one component of the mobile phase. The term “physical parameter” may particularly denote a size or a temperature of the fluid. The term “chemical parameter” may particularly denote a concentration of a fraction of the analyte, an affinity parameter, or the like. The term “biological parameter” may particularly denote a concentration of a protein, a gene or the like in a biochemical solution, a biological activity of a component, etc.

The fluidic chip device may be or may be implemented in different technical environments, like a sensor device, a test device for testing a device under test or a substance, a device for chemical, biological and/or pharmaceutical analysis, a capillary electrophoresis device, a liquid chromatography device, a gas chromatography device, an electronic measurement device, or a mass spectroscopy device. Particularly, the fluidic chip device may be a High Performance Liquid device (HPLC) device by which different fractions of an analyte may be separated, examined and analyzed.

The processing element may be a chromatographic column for separating components of the fluidic sample. Therefore, exemplary embodiments may be particularly implemented in the context of a liquid chromatography apparatus.

The fluidic chip device may be adapted to conduct a liquid mobile phase through the processing element and optionally a further processing element. As an alternative to a liquid mobile phase, a gaseous mobile phase or a mobile phase including solid particles may be processed using the fluidic chip device. Also materials being mixtures of different phases (solid, liquid, gaseous) may be analyzed using exemplary embodiments.

The fluidic chip device may be adapted to conduct the mobile phase through the processing element(s) with a high pressure, particularly of at least 600 bar, more particularly of at least 1200 bar. In the context of such a high pressure application, the corset function of the interconnected reinforcing arrangement may be particularly of interest.

The fluidic chip device may be adapted as a microfluidic chip device. The term “microfluidic chip device” may particularly denote a fluidic chip device as described herein which allows to convey fluid through microchannels having a dimension in the order of magnitude of μm or less.

The fluidic chip device may be adapted as a nanofluidic chip device. The term “nanofluidic chip device” may particularly denote a fluidic chip device as described herein which allows to convey fluid through microchannels having a dimension in the order of magnitude of nm or less.

Exemplary embodiments relate to high performance liquid chromatography plastic chips which may have limitations regarding usable pressure. However, when using laminated structures, there may be a danger of leakage upon application of a high pressure. To meet the above shortcoming, exemplary embodiments provide a plastic chip within a metal corset to counteract the internal pressure by the externally applied corset. As alternatives to a metallic corset, other corset materials may be used, such as a sufficiently stable plastic part or an injection molded part. The chip and the corset may be connected by screwing, lamination, etc., to thereby provide an improved pressure resistance.

During packing separation material within the chip, it is possible to maintain the corset during the fill-in procedure, wherein the corset may be taken off afterwards again.

Particularly in a package material filled channel within such a substrate, pockets may be formed at a border between such a channel and the laminated structures. Such pockets as well as bumps on an external surface of the substrate which may be formed upon application of a high pressure may have a negative impact on the performance of the fluidic chip device and may become more severe with higher operation pressures and smaller devices. However, the provision of an interconnected corset structure may prevent undesired formation of pockets and/or bumps as well as may prevent or inhibit undesired delamination. This may allow to obtain a pressure stability of 1000 bar and more. The mechanical robustness can be improved by exterior lamination of a metal corset or the like onto a structure.

However, according to another exemplary embodiment, it is also possible to integrate at least a part of the reinforcing structures within a sandwich structure. For example, the reinforcing structures may be arranged to enclose a substrate but may be, in turn, externally surrounded by further layers or structures related to the fluidic chip device.

The chip may be encompassed by the reinforcing structures which may form channel-free cover layers, and may particularly provide the reinforcing function by an interconnection. It is possible that one or more additional elements or features are formed on and/or in the reinforcing structures, such as a recessed grip or the like.

When configuring the reinforcing structure, it is also possible to use a material or a dedicated feature promoting a heat exchange or thermal exchange with an environment. For that purpose, it may be advantageous to use steel, a steel sheet, aluminium, copper, titanium, or other metals as a material for the reinforcing structures, and/or to provide thermo-coupling elements in the reinforcing structure.

It is also possible to use a sufficiently rigid plastic such as PEEK (Polyetheretherketone). The use of ceramic materials such as silicon carbide, aluminium oxide, magnesium oxide, etc. for the reinforcing structures is possible as well.

The substrate may be adapted to be connectable with the corset in a reversible or detachable manner, for instance the corset may be applied only for filling separation material in the channel and/or for operating the device under high pressure.

By improving the pressure resistance of the system, the operation safety for a user may be also improved. Therefore, also an existing microfluidic component may be reinforced later, for example by retrofitting.

According to an exemplary embodiment, a microfluidic multi-layer chip (which may comprise laminated layers and may be formed of glass, plastic, metal (for instance having several thin metal sheets connected to one another) and/or ceramic material) having a corset of two enforcement layers may be provided. Such a multi-layer chip (which may be manufactured on the basis of PEEK) on the one hand and the reinforcing layers on the other hand may be manufactured from different materials.

Regarding reinforcing the chips by embodying it with plastic, particularly the following procedures may be implemented:
1. Use transfer or compression molding, this will give the possibility to use thermoset materials
2. Use liquid transfer molding
3. Use injection molding for thermoplastic materials

Particularly, the following materials may be used in case 1: Materials that have acceptable mechanical properties, good chemical resistance and good dimension stability like some grades of Alkyds and phenolics materials.

Particularly, the following materials may be used in case 2: Materials like Polyimide (PI) or different epoxies can be introduced in a transfer mold in liquid state, filling the cavities; after that the materials cure under temperature conditions reinforcing the chips.

Particularly, the following materials may be used in case 3: Materials that fit the specifications of good mechanical properties, chemical resistance and dimension stability such as:
—Fluorocarbons as ETFE that show good mechanical properties
—Nylons like PA610 special grade with lowest moisture absorption
Polyetheretherketone (PEEK) showing excellent mechanical properties
Acetals as POM, with good process ability
Polyarylene Sulfide (PAS) with good mechanical properties
Polyethersulfone (PES)
Polyimide (PI); a thermoplastic grade of the polyimide can be used for injection molding
Polyamide-imide (PAI), as Torlon (r) 465 with lower injection temperature than in case of the PI
Polyphenylene Ether (PPE) which has good process ability
Polyphenylene Sulfide (PPS) is a crystalline thermoplastic with good mechanical properties in case of grade reinforced with 40% glass fibers.

The fluidic conduit may or may not be filled with packing material such as beads for a chromatographic separation. Alternative filling material can be included in the fluidic channel, such as a monolithic separation material. Another configuration relates to an open tubular column. Furthermore, it is possible that no material at all is accommodated in the fluidic channel.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates two different views of a fluidic chip device according to an exemplary embodiment.

FIG. 2 shows a three-dimensional view of a fluidic chip device according to an exemplary embodiment.

FIG. 3 to FIG. 5 illustrate cross-sectional views of fluidic chip devices according to different exemplary embodiments.

The illustration in the drawing is schematically.

### DETAILED DESCRIPTION

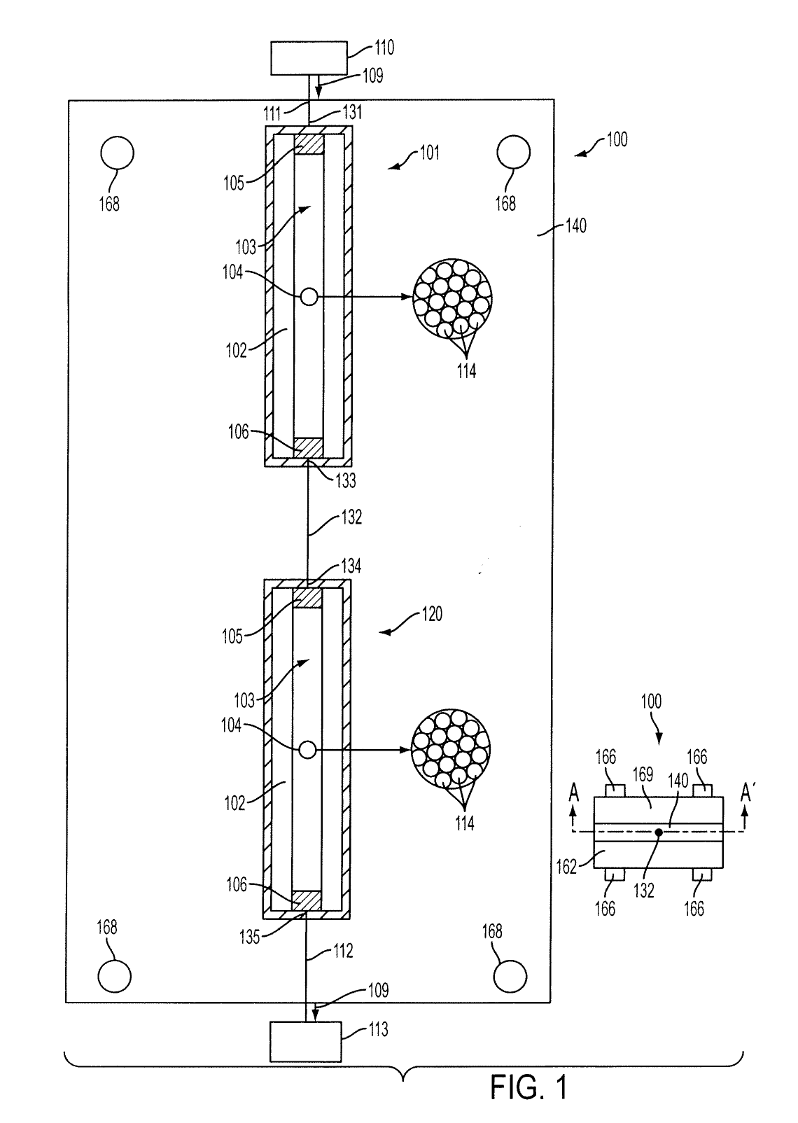

In the following, referring to FIG. 1, a fluidic chip device 100 according to an exemplary embodiment will be explained.

The fluidic chip device 100 is adapted as a system for carrying out liquid chromatography investigations. The fluidic chip device 100 for separating different components of a fluid or a mobile phase which can be pumped through the apparatus 100 comprises a pre-column 101 for pre-processing (for instance sample preparation or sample enrichment) the fluidic sample and comprises an analytical or main column 120 for post-processing the fluidic sample which has already passed the pre-column 101. In other words, the system 100 is a two-stage fluid separation system. Other embodiments may include only a one-stage fluid separation system having only one column, or a multi-stage fluid separation system having multiple (for instance three, four or more) columns.

In the embodiment of FIG. 1, each of the fluid separating columns 101, 120 comprises a column tube 102 which is shaped to define closed packed channels, for instance having a rectangular cross-section. Within each of these fluid separating columns 101, 120, a tubular reception 103 is defined which is filled with a package composition 104.

The fluidic chip device 100 is adapted as a liquid chromatography device 100 and has, in each of the columns 101, 120, a first frit 105 close to an inlet 131, 134 of the respective columns 101, 120, and a second frit 106 provided at an outlet 133, 135 of the respective column 101, 120. The first frit 105 forms the inlet of the respective column 101, 120 and is provided upstream the respective column tube 102. The second frit 106 forms the outlet of the respective column 101, 120 and is located downstream of the respective column tube 102. A flowing direction of the fluid which is separated using the fluidic chip device 100 is denoted with the reference numeral 109.

A fluid pump 110 is provided externally from the chip 100 and pumps fluid under pressure of, for instance, 1000 bar through a connection tube 111 and from there to the inlet 131 of the pre-column 101, through the first frit 105 into the column tube 102. After having left the column tube 102, that is to say after having passed the second frit 106, an intermediate tube 132 connected to an outlet 133 of the pre-column 101 transports the pre-processed analyte to the inlet 134 of the main column 120. The internal construction of the main column 120 is similar to that of the pre-column 101, but may (or may not) differ from the pre-column 101 with respect to size and fluid separating material 114 filled in the tubular reception 103.

In a further stage, the sample is further separated in the main column 120, and the further separated sample leaves the outlet 135 of the main column 120. After having left the column tube 102 of the main column 120, that is to say after having passed the second frit 106 of the main column 120, a second tube or pipe 112 transports the separated analyte to a container and analysis unit 113 positioned outside of the chip 100. The container and analysis unit 113 includes cavities or containers for receiving different components of the fluid, and may also fulfill computational functions related to the analysis of the separated component(s).

The column tubes 102 comprises the filling 104. In other words, a packing composition 104 comprising a plurality of silica gel beads 114 is inserted into the hollow bore 103 of the column tube 102 of each of the columns 101, 120.

The mobile phase is first conducted through the pre-column 101. By selecting an appropriate ACN concentration in a H₂O environment, a fraction of the fluidic sample may first be trapped at a particular position within the column tube 102 of the pre-column 101. This procedure may be denoted as a pre-focusing or pre-separation. Components of the mobile phase which are not trapped in the pre-column 101 are collected in a waste unit (not shown).

Afterwards, the ACN/H₂O concentration ratio within the column tube 102 of the pre-column 101 may be selectively modified so as to elute the sample trapped in the column tube 102 of the pre-column 101. Then, the fluidic sample will move through the outlet 133 of the pre-column 101, and will enter the inlet 134 of the main column 120 to be trapped in a portion close to the outlet of the frit 105 of the main column 120.

When the fluid passes through the main column 120, components which differ from a fraction to be separated may simply pass through the column 120 without being trapped and may be collected in a waste (not shown). At the end of this procedure, a band of the fraction of the fluidic sample of interest is trapped at a particular position within the main column 120. By again modifying the concentration ratio ACN/H₂O, for instance by gradually modifying the respective contributions of these two components, the trapped sample may be released from the main column 120 and may be conducted to the unit 113, for further processing.

Therefore, the fluidic chip 100 is adapted for processing a fluidic sample to be conducted through the fluidic chip device 100. The fluidic chip device 100 comprises a substrate 140 which is a multilayer substrate in which various components of the fluidic chip device are integrated.

The described fluidic chip device 100 is shown in FIG. 1 in a cross-sectional view along a line A-A′, as can be taken from the small illustration in FIG. 1. As can be taken from the small cross-sectional view, the fluidic chip device 100 is formed by the substrate 140 on and/or in which a plurality of components, as described above, such as the fluidic channel 132 is formed. However, the fluidic chip device 100 also comprises, sandwiching the substrate 140, two reinforcing structures 162, 164 which are connected to one another by screws or bolts 166 passing through the plates 164, 162 as well as penetrating through holes 168 formed in the substrate 140. Thus, for fastening the plates 164, 162 at the chip 140, the reinforcing structures 162, 164 having a shape and an area being identical to a surface of the substrate 140 and having through holes aligned with the through holes 168 of the substrate 140 are connected to the substrate 140 via screws or bolts 166 inserted through the holes 168 and connected on the other side, for example by a nut (not shown) formed in components 166. Internal threads may be provided in the through holes of the reinforcing plates 162, 164 and/or in the through holes 168 of the substrate 140.

As can be taken from the small cross-sectional view of FIG. 1, the reinforcing plates 162, 164 have a thickness being larger than a thickness of the substrate 140. Since they are made from steel material, they also have a higher mechanical resistance than the substrate 140 manufactured from PEEK.

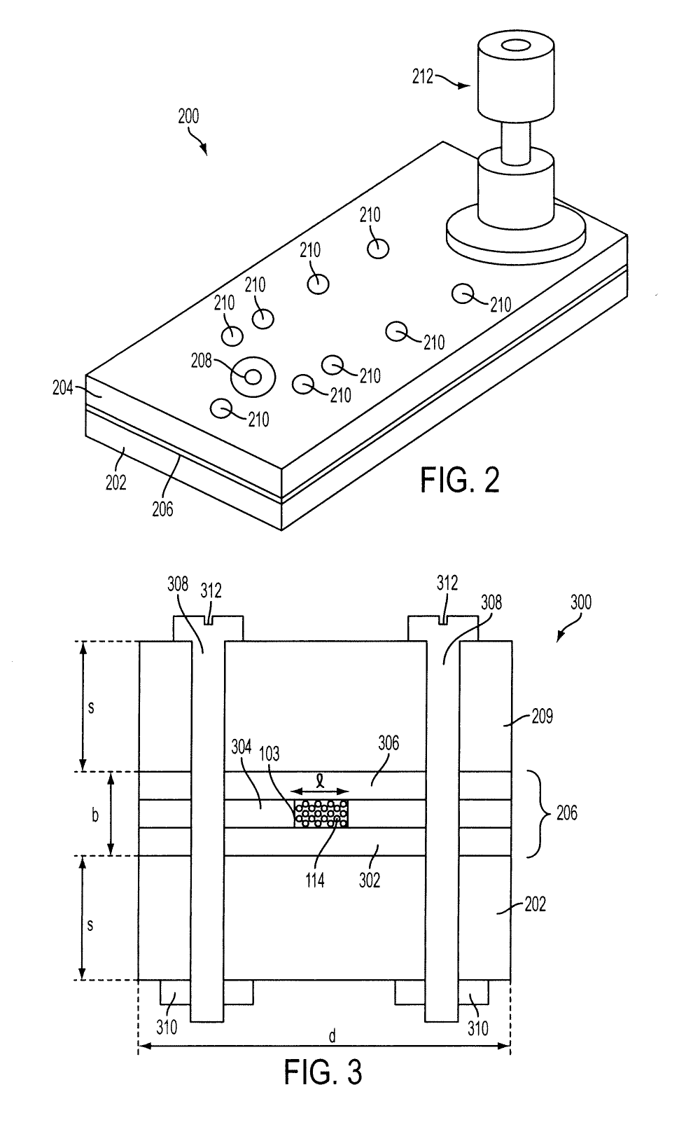

FIG. 2 illustrates a fluidic chip device 200 according to another exemplary embodiment in a configuration for filling beads 114 into a fluidic channel 103 (not shown in FIG. 2).

In FIG. 2, a lower metal plate 202 and an upper metal plate 204 basically surround or sandwich a laminated multi-layer substrate 206 comprising elements required for an HPLC application such as a fluidic channel, beads, a frit, a separation channel, etc.

The fluidic device 200 comprises also a fluidic sample drain opening 208 adapted to drain a fluidic sample discharging from the fluidic conduit (not shown). Thus, an appropriately shaped interface of periphery device may be connected to the drain opening 208 for further processing of the sample.

Moreover, a plurality of screw holes 210 are foreseen in the upper plate 204 through which the threaded metal plates 202, 204 may be connected by screwing, thereby encompassing the substrate 206. An attachment piece 212 is shown as well which is adapted for inserting a separation substance (such as beads) in the fluidic conduit under pressure of, for instance several hundred bars. Thus, when beads or the like are inserted into the channel (not shown) of the substrate 206, the reinforcing effect of the reinforcement plates 202, 204 prevents the multi-layer substrate 206 from delamination or other undesired effects, thereby preventing leaking or deterioration of the substrate 206.

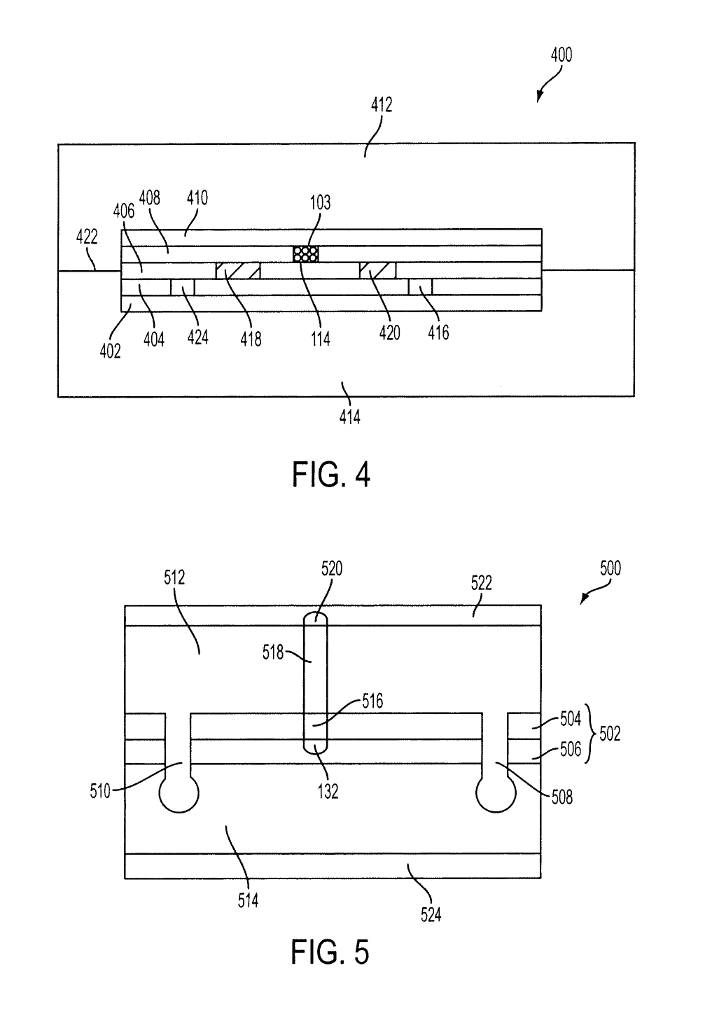

FIG. 3 shows a cross-sectional view of a fluidic chip device 300 according to another exemplary embodiment.

As can be taken from FIG. 3, a multi-layer substrate 206 comprises a lower layer 302, a middle layer 304 having a fluidic channel 103 filled with beads 114, and an upper layer 306. The layers 302, 304 and 306 are connected to one another by lamination, for instance using glue in their connection portions. A through hole is formed through each of components 302, 304, 306 so that a screw 308 can be guided through the aligned through holes, and can be fixed at another end using screw nuts 310, which may be connected to the screw 308 by actuating corresponding screw recesses 312 by a screw driver or the like. A traction connection is thus formed between the reinforcing structures 202, 204 on the one hand and the guide elements 308, 310 on the other hand.

FIG. 3 also shows exemplary dimensions of the various components. An extension d may be 25 mm. An extension l may be between 10 μm and 0.5 mm. A thickness s may be 5 mm. A thickness b may be 100 μm.

FIG. 4 shows a fluidic chip device 400 according to another exemplary embodiment.

In the fluidic chip device 400, a five layer laminated substrate is constituted by a first layer 402, a second layer 404, a third layer 406, a fourth layer 408 and a fifth layer 410. In the fourth layer 408, a channel 103 is formed and is filled with beads 114. In the second layer 404, a separation channel 424, 416 is formed. Electrodes 418, 420 are formed in the third layer 406 which can be used for promoting the sample transport or separation procedure. The upper and lower layers 402, 410 do not comprise any elements contributing to the fluid separation.

An upper enforcement element 412 and a lower enforcement element 414 are arranged to fit to one another and to enclose an accommodation space which completely surrounds the multi-layer structure 402, 404, 406, 408, 410 in a tight manner. Thus, even when a high pressure is applied to insert beads 114 into the channel 103 and/or while pumping a fluidic sample through any one of the structures 103, 424, 416, the encompassing reinforcement structures 412, 414 provide a counterforce preventing delamination of the substrate 402, 404, 406, 408, 410. The reinforcement structures 412, 414 may be fastened at facing surfaces 422 by adhering. Additionally or alternatively, the structures 412, 414 may be made of a magnetic material generating an attracting force between the structures 412, 414, thereby firmly but reversibly connecting the structures 412, 414 based on a magnetic force, thereby simultaneously enclosing the multi-layer substrate 402, 404, 406, 408, 410.

The attracting magnetic force may be formed between permanent magnetic structures 412, 414. Alternatively, a selectively attracting or repulsive (for separating components 412, 414) magnetic force may be formed between magnetic structures 412, 414 when implementing them as an electromagnet structure being operable or switchable by an electric signal.

FIG. 5 illustrates a fluidic device 500 according to still another exemplary embodiment.

In the embodiment of FIG. 5, a two-layer substrate 502 is formed by a first layer 504 and a second layer 506. Both layers 504, 506 comprise a through hole into which protrusions 508, 510 of an upper reinforcement plate 512 extend. These protrusions 508, 510 are received in correspondingly shaped grooves of a grooved second reinforcement plate 514, thereby forming a non-positive locking.

The second layer 506 comprises a fluidic channel 132 which, via a through hole 516 in the first layer 504 and a corresponding through hole 518 in the upper reinforcement structure 512, is in fluid communication with a further fluidic channel 520 in an upper cover layer 522. Furthermore, a lower cover layer 524 is connected to the reinforcement structure 514. Thus, in the embodiment of FIG. 5, the reinforcement structures 512, 514 are embedded between fluidic chip layers 504, 506 on the one hand and cover layers 522, 524 on the other hand.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

What is claimed is:

1. A fluidic chip device adapted for processing a fluidic sample, the fluidic chip device comprising
a substrate comprising a fluidic conduit for conducting the fluidic sample under pressure;
two reinforcing structures between which the substrate is arranged, wherein the two reinforcing structures are connected to one another to reinforce pressure resistance of the substrate.

2. The fluidic chip device according to claim 1,
wherein the two reinforcing structures are plates.

3. The fluidic chip device according to claim 1,
wherein a shape and a surface area of the two reinforcing structures match to a shape and to a surface area of the substrate.

4. The fluidic chip device according to claim 1,
wherein the two reinforcing structures have a thickness being larger than a thickness of the substrate.

5. The fluidic chip device according to claim 1,
wherein the two reinforcing structures have a mechanical resistance being larger than a mechanical resistance of the substrate.

6. The fluidic chip device according to claim 1, comprising at least one of the following features:
the two reinforcing structures are connected to one another to reinforce the substrate by a non-positive locking mechanism;
the two reinforcing structures are connected to one another to reinforce the substrate by a positive locking mechanism;
the two reinforcing structures are connected to one another to reinforce the substrate by a material connection;
the two reinforcing structures are connected to one another to reinforce the substrate by traction anchoring;
the two reinforcing structures are arranged to encompass the substrate;
the two reinforcing structures are connected to one another to reinforce the substrate by at least one connection mechanism of the group consisting of a screwing connection, a clamping connection, and adhering connection, a magnetic connection, and a riveting connection.

7. The fluidic chip device according to claim 1,
wherein at least one of the two reinforcing structures comprises a fluidic sample drain opening adapted to drain a fluidic sample discharging from the fluidic conduit.

8. The fluidic chip device according to claim 1,
wherein at least one of the two reinforcing structures comprises an attachment piece adapted for inserting a separation substance in the fluidic conduit under pressure.

9. The fluidic chip device according to claim 1, comprising at least one of the following features:
at least one of the two reinforcing structures has a thickness in a range between 1 mm and 30 mm, particularly in a range between 2 mm and 10 mm, more particularly in a range between 4 mm and 6 mm;
the substrate has a thickness in a range between 25 μm and 300 μm, particularly in a range between 50 μm and 200 μm, more particularly in a range between 70 μm and 150 μm.

10. The fluidic chip device according to claim 1,
wherein the two reinforcing structures comprise at least one of a metal and a hard plastic.

11. The fluidic chip device according to claim 1,
wherein the two reinforcing structures are formed by injection molding.

12. The fluidic chip device according to claim 1,
wherein the substrate is a multi-layer substrate.

13. The fluidic chip device according to claim 1,
wherein the substrate comprises at least one through hole through which at least one connection element is guided which connects the two reinforcing structures to one another.

14. The fluidic chip device according to claim 1,
comprising a processing element provided in the fluidic conduit and adapted for interacting with the fluidic sample.

15. The fluidic chip device according to claim 14, comprising at least one of the following features:
the processing element is adapted for retaining the fluidic sample being a part a mobile phase and for allowing other components of the mobile phase to pass the processing element;
the processing element comprises a separation column;
the processing element comprises a chromatographic column for separating components of the fluidic sample;
the fluidic chip device is adapted to conduct a liquid sample through the processing element;
the fluidic chip device is adapted to conduct the fluidic sample through the processing element with a high pressure;
the fluidic chip device is adapted to conduct the fluidic sample through the processing element with a pressure of at least 100 bar, particularly of at least 500 bar, more particularly of at least 1000 bar;
at least a part of the processing element is filled with a fluid separating material;
at least a part of the processing element is filled with a fluid separating material, wherein the fluid separating material comprises beads having a size in the range of 1 μm to 50 μm;
at least a part of the processing element is filled with a fluid separating material, wherein the fluid separating material comprises beads having pores having a size in the range of 0.02 μm to 0.03 μm.

16. The fluidic chip device according to claim 1, comprising at least one of the following features:
the substrate comprises a plurality of layers which are connected to one another by lamination;
the substrate comprises a top layer, a bottom layer, and at least one intermediate layer sandwiched between the top layer and the bottom layer;
the substrate comprises a top layer, a bottom layer, and at least one intermediate layer sandwiched between the top layer and the bottom layer, wherein at least one of the at least one intermediate layer comprises the fluidic conduit through which the fluidic sample is to be conducted;
the substrate comprises a top layer, a bottom layer, and at least one intermediate layer sandwiched between the top layer and the bottom layer, wherein at least one of the at least one intermediate layer comprises an electrode structure to which an electric voltage is to be applied;
the substrate comprises at least one material of the group consisting of a plastic, a polymer, a metal, a semiconductor, and a ceramic;
the substrate has an essentially rectangular cross section;
the substrate has a plate shape;
the fluidic chip device is adapted as a fluid separation system for separating compounds of the fluidic sample;
the fluidic chip device is adapted as a fluid purification system for purifying the fluidic sample;
the fluidic chip device is adapted to analyze at least one physical, chemical and/or biological parameter of at least one compound of the fluidic sample;
the fluidic chip device comprises at least one of the group consisting of a sensor device, a test device for testing a device under test or a substance, a device for chemical, biological and/or pharmaceutical analysis, a capillary electrophoresis device, a liquid chromatography device, an HPLC device, a gas chromatography device, a gel electrophoresis device, an electronic measurement device, and a mass spectroscopy device;
the fluidic chip device is adapted as a microfluidic chip device;
the fluidic chip device is adapted as a nanofluidic chip device.

17. A method of fabricating a fluidic chip device for processing a fluidic sample, the method comprising
forming a fluidic conduit in a substrate through which fluidic conduit the fluidic sample is to be conducted under pressure;
arranging the substrate between two reinforcing structures;
connecting the two reinforcing structures to one another to reinforce pressure resistance of the substrate.

18. The method according to claim 17, further comprising
inserting a separation substance in the fluidic conduit under pressure;
removing the two reinforcing structures after the inserting and before conducting the fluidic sample through the fluidic conduit.

19. The method according to claim 17, further comprising
maintaining the two reinforcing structures enclosing the substrate while conducting the fluidic sample through the fluidic conduit under pressure.
